(19) United States
(12) Patent Application Publication
(10) Pub. No.: US 2004/0064357 A1
(43) Pub. Date: Apr. 1, 2004

(54) System and method for increasing the accuracy of forecasted consumer interest in products and services

(76) Inventors: Jeffrey D. Hunter, Plymouth, MN (US); Sharon M. Hoeting, Shorewood, MN (US)

Correspondence Address: GENERAL MILLS, INC., P.O. BOX 1113, MINNEAPOLIS, MN, 55440, US

(21) Appl. No.: 10/255,547

(22) Filed: Sep. 26, 2002

(51) Int. Cl. G06F 17/60

(52) U.S. Cl. 705/10

(57) ABSTRACT

For new and experimental products for which no actual purchasing behavior is measurable, consumer behavior forecasting data is collected and then corrected based on a comparison of forecasted versus actual measured behavioral data for existing, “similar” products. The illustrative embodiment selects products or services that are (a) “similar” (based on various objective and subjective criteria) to the new product or service, and (b) are at a stage where actual consumer behavior can be measured. A computer then analyzes predicted consumer behavior forecasts for this “similar” product(s) or service(s) versus actual measured consumer behavior to determine a correction factor. This correction factor is then applied to correct predicted consumer behavior forecasts for a new product or service for which no actual consumer behavior can yet be measured. The resulting corrected forecasts more accurately reflect likely actual consumer behavior by taking into account errors inherent in the potential consumer survey process.

### CROSS-REFERENCES TO RELATED APPLICATIONS

Not applicable

### FIELD OF THE INVENTION

The present invention is directed to a system and method for modifying or correcting data collected from consumer panels, focus groups or other test participants to provide a more accurate forecasting tool for product launches or reintroductions or concept testing.

### BACKGROUND OF THE INVENTION

Developing, manufacturing and marketing a new product or service—even just bringing the product or service to the test-marketing stage—can represent a significant investment of time, effort and other resources such as cost. To reduce the risk of introducing products and services not desired by consumers and better serve customers, it is common, prior to committing resources for launching a new product or concept, to explain the idea of a product or concept to a test panel, focus group or other set of actual consumers and ask them whether they would be interested in purchasing or using the product or concept. Such pre-launch consumer interest survey are intended to give marketers a better idea about whether consumers would actually buy potential new products or services, how often (or likelihood of repeat purchases) and how many units or what size they would purchase, how much they would pay, etc. In addition, such surveys can also be used to determine interest in advertising and preferences for packaging types, such as paperboard, plastic, etc.

Pre-launch surveys can be accomplished in a number of different ways. For example, surveys can be conducted in an interview setting, where prescreened or randomly selected participants are brought to an interview room. They may also be done by other techniques such as telephonically, through direct mail surveys or even over the Internet. Questionnaires can be delivered in a variety formats. Sampling can be used to determine consumer likes and dislikes. While such pre-launch surveys are generally not as accurate as a limited test-marketing campaign, such as one that would occur in a selected market or demographic, they are relatively inexpensive to conduct and can yield valuable information for deciding whether to proceed to the next stage of introducing or marketing a new product or further developing a service offering.

While pre-launch data can be very useful, it can often give inaccurate expectations and predictions about the probably success of a new product or concept—creating potentially skewed results compared with post launch sales. Such a situation can be embarrassing for a manufacturer and agency that conducted the pre-launch surveys if expected/predicted purchasing levels as suggested by the are not attained. Inaccurate expectations of success of a new product or concept can, for example, create disappointing results after the product is launched and the hoped for “numbers” or purchasing levels are not present. Similarly, it is possible under some circumstances for marketers to underestimate the demand for a new product or service—causing demand to far exceed supply and creating a whole different set of problems for the supplier. Inability to supply the market with product, can strain relationships with retailers and discourage consumers from seeking out the desired products or services.

Survey results can sometimes indicate inaccurate consumer purchase preferences. This may be due to test panel participants or subjects providing feedback that does not match their actual behavior or purchasing habits. While a few consumers in a survey may intentionally supply incorrect answers because they want to be invited back for other surveys or test product sampling, most participants generally try to be as accurate as possible but their answers may not exactly correspond to their actual behavior. This change in circumstances may be due to a number of different reasons. One such reason is that test panelists sometimes don't understand the survey questions or may find the questions to be confusing or misleading. For example, in the food context, panelists might confuse the terms “refrigerated” and “frozen,” and give a survey response, which assumes an inaccurate product characteristic. Another reason for inaccuracy may be that the panelist is flattered that someone is asking for their opinion, and consequently is overly polite to the interviewer and indicates interest in the product even though the consumer wouldn't have enough interest in the actual product to seek it out and pay hard-earned money to buy it. Still other reasons may include errors in inputting or compiling survey responses and other factors. All of the foregoing can lead to inaccurate or skewed data when trying to interpret whether to continue supporting a product or service offering.

Much work has been tried in the past to make marketing survey results more accurate. However, what is needed is a technique for somehow taking inaccuracies of conventional consumer preference assessments into account while nevertheless providing a more accurate assessment or predictor of consumer interest in potential new products and services. A technique or assessment process for which no actual consumer behavioral information is yet available or measurable, that is, no similar products exist in the market place today would also be beneficial.

### SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Briefly, an illustrative embodiment of the present invention selects existing products or services that are (a) “similar” (based on various objective and subjective criteria, such as SIC code, package size, flavor type, etc.) to the new product or service, and (b) are at a stage where actual consumer behavior can be measured, that is the sales or consumer interest in the existing products can be measured. A computer then analyzes the predicted consumer behavior forecasts for this “similar” product(s) or service(s) versus actual measured consumer behavior from existing products to determine a correction factor. This correction factor is then applied to correct the predicted consumer behavior forecasts that have been obtained from the concept testing surveys for a new product or service for which no actual consumer behavior can yet be measured.

In accordance with an illustrative, exemplary aspect of a presently preferred example embodiment of the present invention, to give a more accurate view of what a customer or particular demographic may purchase, predictive data concerning purchasing interest and habits of a potential new product or service is collected using conventional survey or sampling techniques to estimate what the “claimed” purchasing levels will be. The term “claimed” in this context refers a consumer panelist's indication as to whether he or she will purchase a particular product or service, the frequency of such purchases, the number of units the consumer will purchase, the size or packaging type, acceptable purchase price ranges, and other purchasing behavior characteristics. This collected data is then compared with data collected from sources showing actual purchasing behavior of similar or existing products. For example, in a food context such as launching a new cake mix or cookie product, the actual purchasing levels for existing cake mixes or cookie products would be used. This actual data can be retrieved and provided according to a particular territory or demographic of the population.

Comparison of “claimed” and “actual” data for existing, similar products or services yields a ratio indicating the relative accuracy of the “actual” results. Such comparison can be based on a simple division calculation, or more sophisticated statistical (e.g., regression) analysis can be used to make the comparison or other mathematical algorithm that facilitates the generation of a ratio to make an appropriate adjustment. The comparison result(s) can be used to adjust the forecast for the product or service of the concept test or launch to generate a more realistic and accurate representation of expected purchasing levels for the new product or service to be introduced.

The foregoing technique can be used at the concept stage to determine the probable success of a new product or concept; and/or at the actual “product stage” to adjust the eventual volume a particular product or concept may generate. The technique can also be used at various stages of the “sell cycle” in order to further refine and adjust requirements relating to manufacturing and inventory.

In more detail, one illustrative aspect of a presently preferred exemplary embodiment provides a system and method for modifying or correcting data that has been collected from consumer panels, focus groups or other test participants to provide for a more accurate forecasting tool for new product launches or concept introductions. To give a more accurate view of what a customer or particular demographic may purchase, data concerning “claimed” purchasing habits (e.g., panelists saying how many times he or she will purchase the product) is collected using various survey or sampling techniques. This data is then compared with data collected from sources showing actual purchasing habits for similar products in related demographic breakdowns, and a ratio is determined. This ratio is used to adjust the forecast provided by the collected data to generate a corrected representation of expected purchasing levels.

The preferred illustrative embodiment of a system for accurately predicting consumer demand for a product or service comprises a data collection arrangement that collects data indicating whether consumers are likely to exhibit a predetermined behavior with respect to products or services; a consumer behavior measuring arrangement that measures actual consumer behavior; and a calculation arrangement that compares predicted likely consumer behavior with actual measured consumer behavior to generate a correction factor for application to predicted consumer behavioral data with respect to which no actual consumer behavior can yet be measured.

A still further exemplary method of predicting consumer behavior comprises collecting data forecasting consumer purchasing behavior for a plurality of consumer offerings; measuring actual consumer purchasing behavior for said plurality of consumer offerings; calculating the divergence between said forecasting data and said actual behavioral data; collecting data forecasting consumer behavior with respect to an offering for which no or inadequate measurement of actual consumer behavior is available; and correcting said collected data referred to in said last-mentioned step based on said calculated divergence.

### BRIEF DESCRIPTION OF THE DRAWINGS

These and other features and advantages of presently preferred illustrative exemplary embodiments will be better and more completely understood by referring to the following detailed description in connection with the drawings, of which:

FIG. 1 shows a schematic block diagram of an exemplary illustrative system;

FIG. 2 shows an overall high-level exemplary illustrative flow diagram of a presently preferred exemplary embodiment;

FIG. 2A shows a flow diagram of an exemplary illustrative calculation/analysis performed by the data comparator/predictor computer of FIG. 1;

FIG. 3 shows an exemplary illustrative market penetration/ratio calculation worksheet;

FIG. 4 shows an exemplary illustrative market penetration graph/plot;

FIG. 5 shows an exemplary illustrative purchasing frequency/ratio calculation worksheet;

FIG. 6 shows an exemplary illustrative purchasing frequency graph/plot;

FIG. 7 shows an exemplary illustrative repeat/number of units/ratio calculation worksheet; and

FIG. 8 shows an exemplary purchasing repeat/number of units graph/plot.

### DETAILED DESCRIPTION OF PRESENTLY PREFERRED EXEMPLARY ILLUSTRATIVE EMBODIMENTS

The foregoing and other objects of the invention will become clear from an inspection of the detailed description of the invention and from the appended claims.

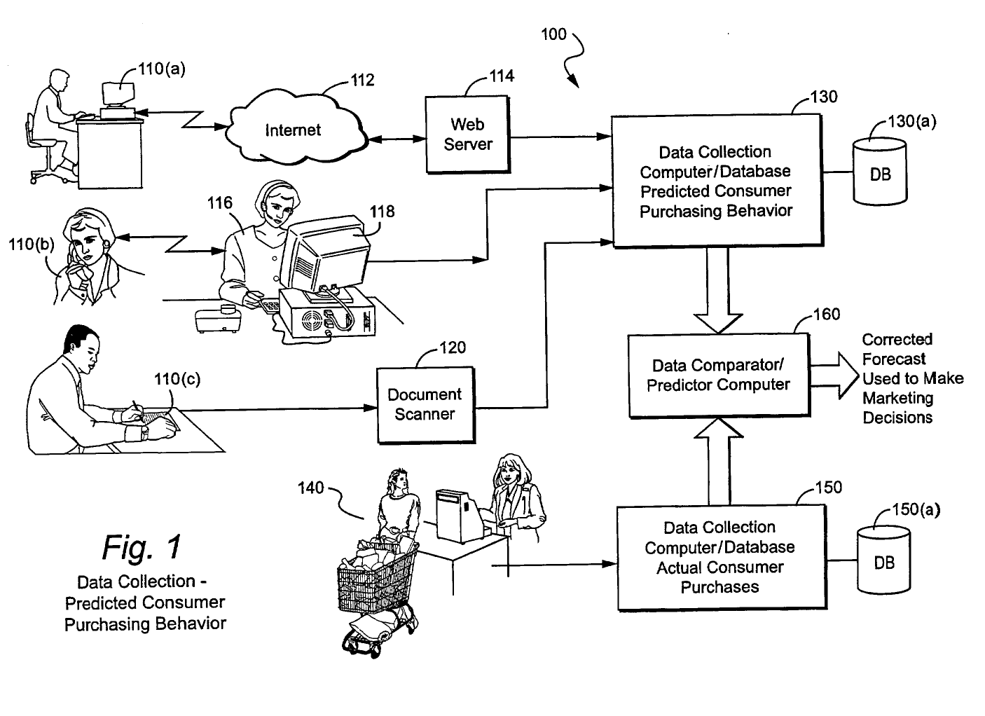

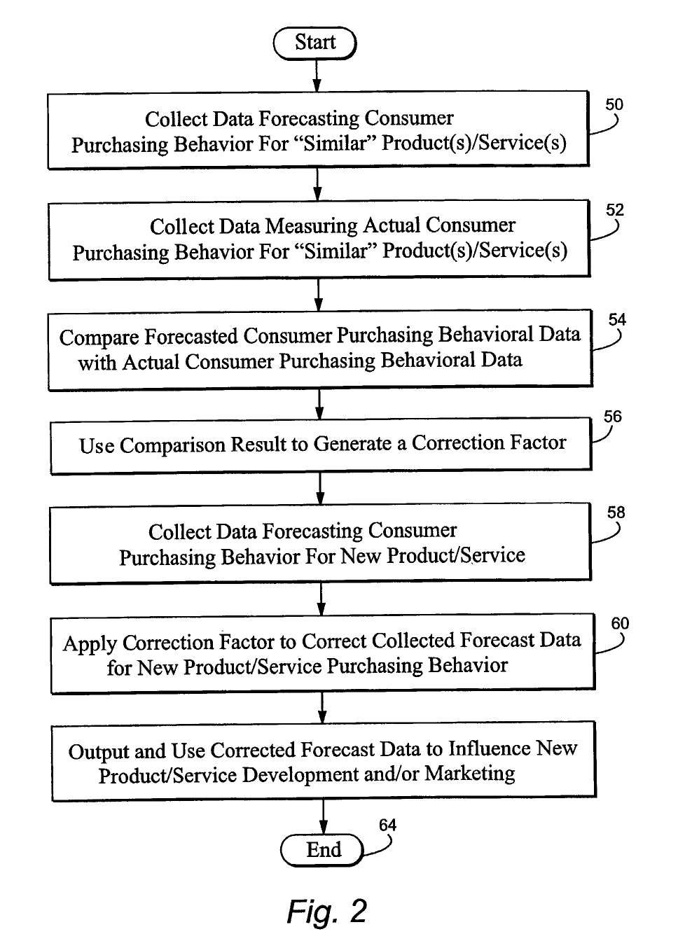

FIG. 1 shows an exemplary illustrative overall consumer behavior prediction system, and FIG. 2 is an example flow diagram of an illustrative process performed by the FIG. 1 system. Referring to FIGS. 1 and 2 together, the FIG. 1 system 100 includes various data collection mechanisms 110 (e.g., networked personal computers and other Internet appliances 110(a), telephone 110(b), and data entry forms 110(c), for example) that are used to collect data forecasting consumer purchasing behavior for existing products/services that are “similar” to the new product or service being contemplated (FIG. 2, block 50). As shown in FIG. 1, these various mechanisms 110 use different data transmission paths (e.g., the Internet 112 and associated web server 114 in the case of web appliance 110(a); a telephone operator 116 entering data in a data entry terminal 118 in the case of telephonic interviews using telephone 110(b); and document scanner 120 in the case of filled-in forms 110(c)) to collect data and provide it to a data collection computer/database 130. The mechanisms shown in FIG. 1 are not exhaustive—other conventional ways of gathering data concerning predicted consumer purchasing behavior are known and any such techniques may be used.

Generally, such techniques ascertain predicted consumer purchasing behavior by surveying the potential consumer of a product or service. Generally, such surveys explain or identify the product/service and elicit consumer responses as to predicted consumer purchasing behavior (e.g., whether the consumer would purchase the product, how often the consumer would purchase the product, how many units of the product the consumer would purchase at one time, whether the product purchasing behavior would be repeated on a seasonal or other basis, etc.).

The preferred illustrative embodiment uses conventional arrangements 140 such as grocery or other store scanners, inventory control systems, other surveys, etc. to collect data measuring actual consumer purchasing behavior for such “similar” products/services. This data is collected and stored in an actual consumer purchases data collection computer/database 150. If desired, the various data collected by FIG. 2 blocks 50, 52 may be broken down demographically, by territory, or in any other desirable fashion as is well known to those skilled in the art.

In the exemplary illustrative embodiment, a data comparator/predictor computer 160 compares the forecasted consumer purchasing behavioral data for the “similar” products/services with the actual consumer purchasing behavioral data compiled by the data collection computer/database 150 (see FIG. 2, block 54). The data comparator/predictor computer 160 uses the result of the comparison to generate a correction factor indicating the difference or “spread” (divergence) between forecasted and actual consumer purchasing behavioral data for “similar” products with respect to which it is possible to measure actual consumer purchasing behavior (FIG. 2, block 56).

The preferred exemplary illustrative embodiment also uses data collection arrangements 110 to collect data forecasting consumer purchasing behavior for the potential new product/service (FIG. 2, block 58). Thus, for example, an additional survey is performed via the Internet 112, by telephone 110(b), via personal interviews or mailed-out forms 110(c), etc.—and the resulting predicted consumer purchasing behavior data is collected by computer/database 130.

In the exemplary embodiment, this collected data is corrected by applying the correction factor calculated by data comparator/predictor computer 160 at FIG. 2, block 56 to correct the collected forecast data for the new product or service purchasing behavior (FIG. 2, block 60). The data comparator/predictor computer 160 outputs the corrected forecast data so it can be used to influence new product/service development and/or marketing (FIG. 2, block 62).

In the illustrative example described above, it is preferable that the “similar” products or services occur within the same general marketing channels and involve the same types of consumers. For example, if the new product being contemplated is a cookie mix, it may be desirable to look at other, existing cookie mixes within the same general price range, package size, flavor types and other items relating to overall consumer appeal of the offering. The more “similar” the existing product/service is to the new product/service being contemplated, the more likely it is that the correction factor will be accurate. For example, in introducing a new package containing 24 “place and bake” chocolate chip cookies one would look to competitive refrigerated offerings of chocolate chip cookies that may come in a sheet or a dough tube to get an accurate correction factor.

It may be desirable to use historical data for the predicted and actual customer purchasing behavioral data for “similar” existing products or services. Sometimes, consumers polled in a survey will react differently to questions about “new” products or services than they react to questions concerning products or services that they are already familiar with. For example, when a consumer is asked whether or nor he or she will purchase a product that he or she is already familiar with and has an existing purchasing (or non-purchasing) history with respect to, the consumer's answers may be significantly more accurate than with respect to products that the consumer has never heard of before. On the other hand, surveys can be appropriately designed to exclude or take into account answers that may be biased one way or another based upon familiarity with the product or other factors, such as by prefacing the survey segment with a question that identifies whether the product or service has been purchased before. Generally, the goal is to have the data collection or surveying techniques that are used to collect predicted purchasing behavior data with respect to products that have not yet been launched match, as closely as possible with, the data collection techniques used to collect predicted consumer behavior data collected for products which have already been launched and therefore for which actual consumer purchasing behavioral data is available. In such instances, the comparison between actual and predicted consumer purchasing behavioral data can be used to interpret more accurately the predicted consumer behavioral data for products for which no actual consumer purchase behavioral data can yet be collected.

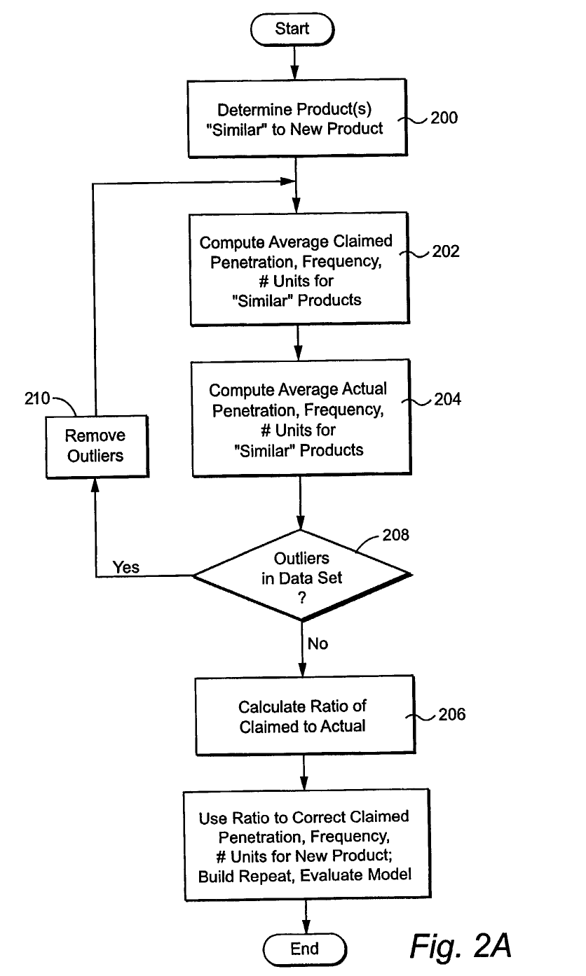

FIG. 2A shows a more detailed exemplary illustrative process for performing the comparison and collection factor application steps. FIG. 2, blocks 56, 60, and FIGS. 3-8 show exemplary illustrative spreadsheet-type calculation forms that may be used to implement the various computations on the data comparator/predictor computer 160. Referring to FIG. 2A, the first step is to determine some number of products that are “similar” to the new product being contemplated (FIG. 2A, block 200). Referring to FIG. 3, in the particular example of a new type of cookie dough, for example, a number of different existing products may be selected including a number of different refrigerated cookie doughs, brownie mixes, cookie mixes, muffin mixes, etc. The forecasted and actual purchase data (i.e., market penetration) for these various items are averaged to provide two different averages (FIG. 2A, blocks 202, 204), and the ratio of “claimed” (i.e., forecasted) to actual data is calculated (FIG. 2A, block 206). In the specific illustration shown in FIG. 3, for example, the average indication of whether or not a potential consumer would purchase a particular product obtained from surveys was significantly higher than the actual purchasing behavior once the product was actually released. In this particular illustration, the resulting ratio is calculated at 1.63—meaning that on average, about 61.5% of consumers who said in a premarketing survey that they would be likely to purchase a particular product actually ended up purchasing that product once it was released to market.

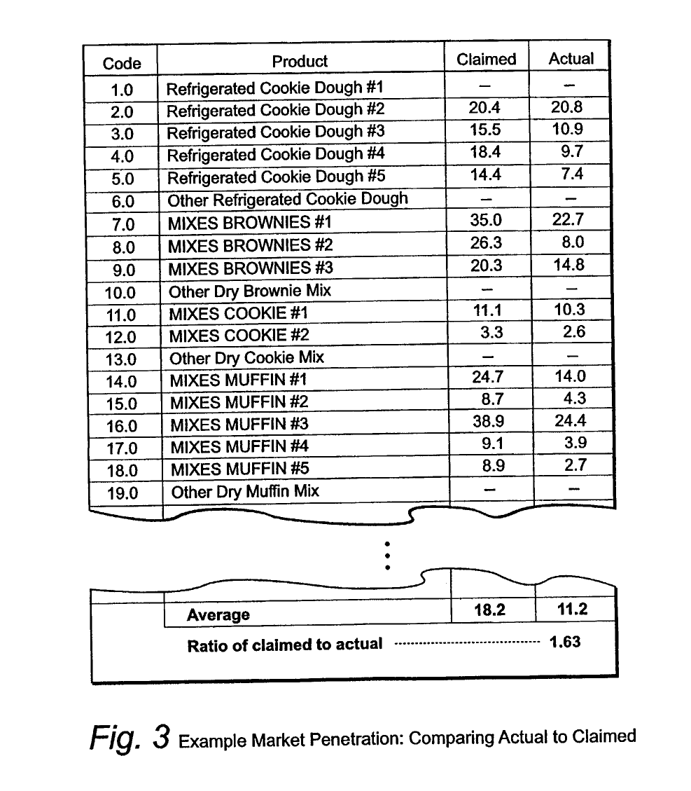

An additional statistical analysis represented by FIG. 2A, blocks 208, 210 and the FIG. 4 graphical illustration can be used to remove “outliers” from the data set in order to improve the accuracy of the correction factor. As those skilled in the art well understand, statistical analyses of various types may be used to process a data set in order to avoid biasing the end result based upon anomalous results. The averaging performed by blocks 202, 204 may be repeated iteratively as often as is necessary by including or excluding different “similar” products from the calculation and removing “outliers” to provide a more accurate ratio of claimed to actual customer purchasing behavior.

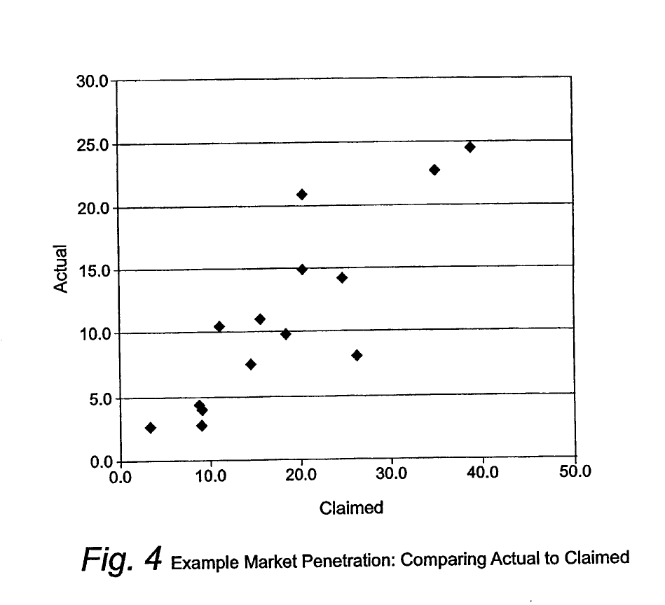

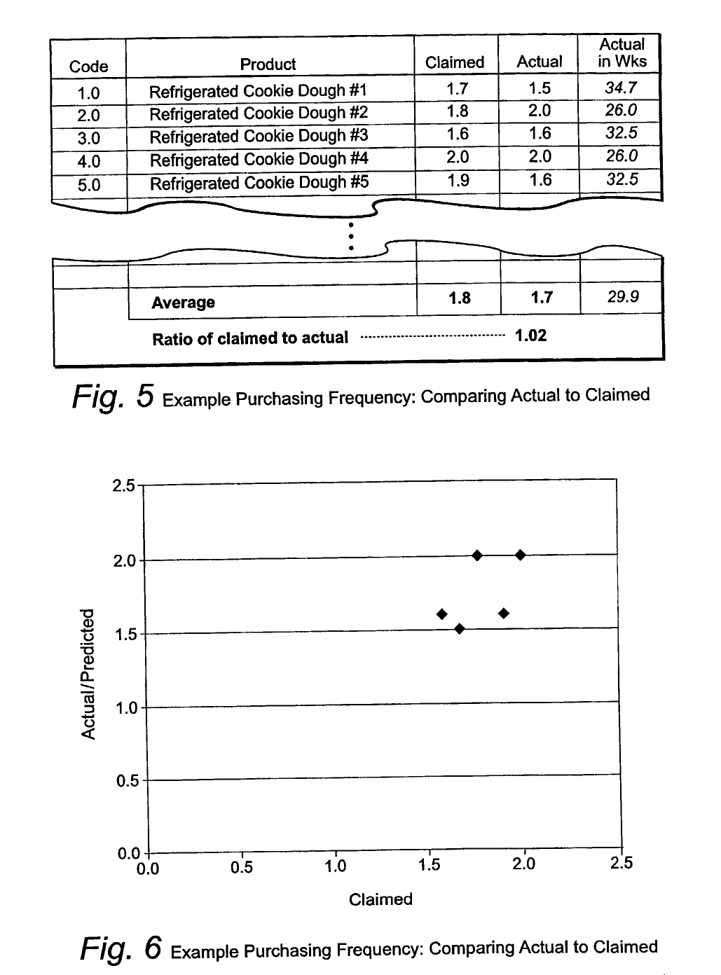

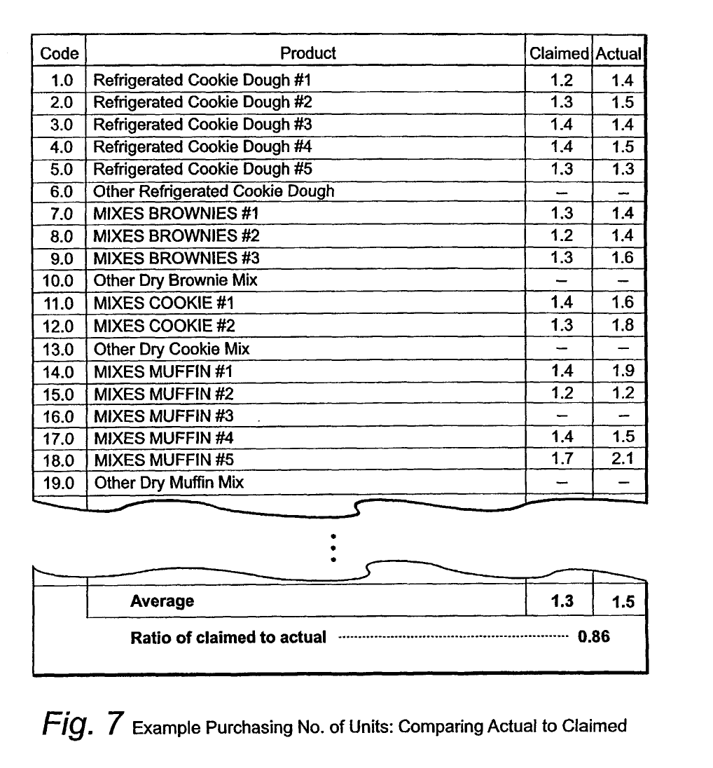

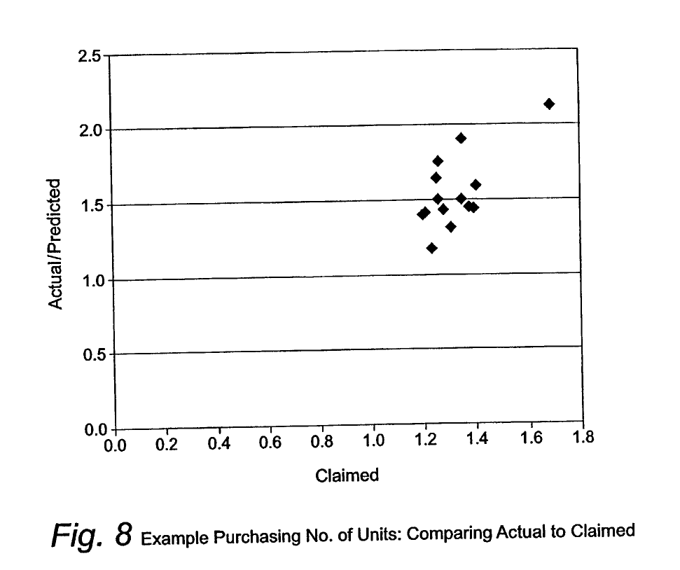

FIGS. 5 and 6 show that the same steps performed by FIG. 2A, blocks 200-210 may be implemented for different purchasing behavior characteristics such as purchasing frequency (see FIGS. 5, 6) and purchasing unit numbers (i.e., the number of units a consumer would purchase at one time) (see FIGS. 7, 8). As illustrated in FIGS. 3-8, different “similar” products may be used to calculate correction ratios for different behavioral characteristics. For example, in the illustration shown, fourteen different “similar” products including a range of refrigerated cookie doughs, brownie mixes, cookie mixes and muffin mixes may be appropriate for calculating a ratio with respect to market penetration (i.e., whether or not the consumer will purchase). However, as shown in FIG. 5, perhaps only one category of product (e.g., refrigerated cookie doughs) might be used to calculate the ratio with respect to purchasing frequency (note that in this case, the correction factor with respect to purchasing frequency was relatively slight meaning that the predicted and actual behavior closely matched).

The FIG. 7 example shows that it may be desirable to use a relatively similar data set for estimating or predicting number of units purchased as is used for estimating market penetration. Determining the data set is not, however, an exact science—it is typically desirable to use empirical factors and several iterations before one arrives at an appropriate data set from which computer 160 can automatically calculate an appropriate correction factor and automatically apply such correction factor to predicted consumer purchasing behavior data to arrive at corrected forecasts.

The techniques described above can be used and applied to a wide variety of different predictive behaviors. They are not limited, for example, to consumer behavior but can be used for virtually any type of human behavior for which survey data is available and accurate measurements of actual behavior can be made. Additionally, these techniques are not intended to be exclusive—they may be combined with other well-known statistical and other techniques such as regression analysis, conjunctive methods, case summaries, trials based on a number of different factors (e.g., ratio from test products, 60% of certain selectors, 2% occasional buyers, no barriers to trial, etc., preview and evaluator analysis based on modeling volume models, square root analysis, repeat analysis, weighted analyses, volume distributions, etc.).

It will thus be seen according to the present invention a highly advantageous system and method for increasing the accuracy of forecasted consumer interest in products and services has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

We claim:

1. A method for modifying or correcting data collected from consumer panels or other test participants to provide for a more accurate forecasting tool for product or concept launches, comprising:
collecting first data forecasting purchasing behavior for a particular product and/or demographic;
collecting second data showing actual purchasing habits for similar products/demographics;
determining a ratio between said first and second data; and
using said ratio to adjust the forecast provided by the first data to generate a corrected representation of forecasted purchasing behavior.

2. A method for modifying or correcting data as recited in claim 1, wherein the product or concept launches are food products.

3. A system for accurately predicting consumer demand for a product or service comprising:
a data collection arrangement that collects data indicating whether consumers are likely to exhibit predetermined behavior with respect to products or services;
a consumer behavior measuring arrangement that measures actual consumer behavior; and
a calculation arrangement that compares predicted likely consumer behavior with actual measured consumer behavior to generate a correction factor for application to predicted consumer behavioral data with respect to which no actual consumer behavior can yet be measured.

4. The system of claim 3 wherein said data collection arrangement includes a web server.

5. The system of claim 3 wherein said data collection arrangement includes a telephonic interviewing subsystem.

6. The system of claim 3 wherein said data collection arrangement includes a document scanner.

7. The system of claim 3 wherein said consumer behavior measuring arrangement includes a point of sale purchase data acquisition system.

8. The system of claim 3 wherein said calculation arrangement calculates an average of claimed and actual consumer behavior for a plurality of products, generates a ratio based on said averages, and applies said ratio to correct predicted consumer behavioral data.

9. The system of claim 3 wherein said calculation arrangement provides for removal of anomalous data.

10. The system of claim 3 wherein said system is used to accurately predict consumer demand for food products.

11. A method of predicting consumer behavior comprising:
(a) collecting data forecasting consumer purchasing behavior for a plurality of consumer offerings;
(b) measuring actual consumer purchasing behavior for said plurality of consumer offerings;
(c) calculating the divergence between said forecasting data and said actual behavioral data;
(d) collecting data forecasting consumer behavior with respect to an offering for which no or inadequate measurement of actual consumer behavior is available; and
(e) correcting said collected data referred to in said last-mentioned step based on said calculated divergence.

12. A method of predicting consumer behavior as recited in claim 11, wherein said consumer offerings are food products.

13. A method of predicting consumer behavior comprising:
(1) selecting products or services that are (a) “similar” to a new product or service, and (b) are at a stage where actual consumer behavior can be measured;
(2) using a computer to analyze predicted consumer behavior forecasts for this “similar” product(s) or service(s) versus actual measured consumer behavior to determine a correction factor; and
(3) applying said correction factor to correct predicted consumer behavior forecasts for a new product or service for which no actual consumer behavior can yet be measured.

14. A method of predicting consumer behavior as recited in claim 13, wherein said new product or service is a food offering.
